(19) United States
(12) Patent Application Publication
(10) Pub. No.: US 2007/0205970 A1
(43) Pub. Date: Sep. 6, 2007

(54) POWER-SAVING DEVICE FOR DRIVING CIRCUITS OF LIQUID CRYSTSAL DISPLAY PANELS

(76) Inventors: Wing-Kai Tang, Hsinchu City (TW); Ming-Chieh Lin, Hsin-Chu County (TW); Wen-Shian Shie, Taipei City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/308,929

(22) Filed: May 26, 2006

(30) Foreign Application Priority Data
Mar. 3, 2006 (TW) 95107168

(51) Int. Cl. G09G 3/36

(52) U.S. Cl. 345/87

(57) ABSTRACT

A power-saving device for a driving circuit of a liquid crystal display panel is provided. The device comprises a first switch, a first capacitor, a second switch, a second capacitor, a third switch, an output buffer and a common electrode or a data line. The first capacitor and the second capacitor are coupled to the common electrode or the data line through the first switch and the second switch respectively. The output buffer is coupled to the common electrode or the data line through the third switch. The output buffer charges or discharges a ground-referenced equivalent capacitor of the data line or the common electrode. The device uses the switches to conduct positive and negative electric charges to the capacitors so that charges produced during the charging and discharging in the driving circuits of the common electrodes and data line can be stored and recycled to avoid unnecessary power waste.

### CROSS-REFERENCE TO RELATED APPLICATION

This application claims the priority benefit of Taiwan application serial no. 951 071 68, filed on Mar. 3, 2006. All disclosure of the Taiwan application is incorporated herein by reference.

### BACKGROUND OF THE INVENTION

1. Field of the Invention

The present invention relates to a power-saving device, and more particularly, to a power-saving circuit for a driving circuit of a liquid crystal display panel.

2. Description of Related Art

Liquid crystal display panel is a device that displays brightness levels by applying voltages between the source terminals of thin-film transistors and a common electrode to drive liquid crystal molecules. However, if the same voltage is applied to the liquid crystal molecules for a prolonged display with the same brightness level, some of the characteristics of the liquid crystal molecules may be compromised. When this happens, the liquid crystal molecules can no longer be rotated properly in response to a changing electric field. To avoid such an occurrence, the source line voltage and the common electrode voltage are switched alternately. This switching is practical because it is the absolute difference in voltage applied to liquid crystal molecules that determines the displayed brightness level. The aforementioned source line is also known as data line. Typically, the source voltage is defined as positive polarity when the source voltage is higher than the common voltage. Conversely, the source voltage is defined as negative polarity when the source voltage is lower than the common voltage. FIG. 1 is a timing diagram of source voltages and a common voltage. To simplify the explanation of the alternate switching of the source voltage and the common voltage, the horizontal axis represents time and the vertical axis represents voltage. The voltage 110 on the common electrode is V10 during the time interval 0 to T11. The voltages 111, 112, 113, 114 on the source lines are V11, V12, V13, V14 respectively. Then, during the time interval T11 to T12, the voltage 110 on the common electrode changes to V14 while the voltages 111, 112, 113, 114 on the source lines also change to V13, V12, V11, V10 respectively. Therefore, during the time interval 0 to T11 and during the time interval T11 to T12, the source voltages and the common voltage are simultaneously changed to reverse their driving polarities without changing their absolute voltage difference.

FIG. 2 is a circuit diagram of a conventional driving device for a liquid crystal display panel. As shown in FIG. 2, the output buffer 201 drives the common electrode 210 of the display panel 202, and the common electrode 210 has a ground-referenced equivalent capacitor C2. To switch the voltage, the output buffer 201 must charge and discharge the ground-referenced equivalent capacitor C2 repeatedly so that considerable power is wasted in the process.

### SUMMARY OF THE INVENTION

Accordingly, at least one objective of the present invention is to provide a power-saving device for a driving circuit of a liquid crystal display panel, particularly suitable for a liquid crystal display panel using an alternating common voltage. The charges released, when a common electrode is charged or discharged, can be stored and recycled so that less power is wasted and more power is conserved.

At least another objective of the present invention is to provide a power-saving device for a driving circuit of a liquid crystal display panel suitable for storing and recycling the electric charges released when a data line is charged or discharged so that power is saved.

At least yet another objective of the present invention is to provide a power-saving device for a driving circuit of a liquid crystal display panel suitable for storing and recycling the electric charges released when a plurality of data lines is charged or discharged so that power is saved.

To achieve these and other advantages and in accordance with the purpose of the invention, as embodied and broadly described herein, the invention provides a power-saving device for a driving circuit of a liquid crystal display panel. The device is suitable for a liquid crystal display panel using an alternating common voltage. The device comprises a common electrode, a first switch, a first capacitor, a second switch, a second capacitor, a third switch and an output buffer. The common electrode is used for providing a common voltage to the liquid crystal display panel. The first switch is coupled to the common electrode. Also, the first capacitor is coupled to the first switch for storing positive electric charges. The second capacitor is coupled to the common electrode. Furthermore, the second capacitor is also coupled to the second switch for storing negative electric charges. The third switch is coupled to the common electrode and the output buffer is coupled to the third switch so that the output buffer either charges or discharges a ground-referenced equivalent capacitor of the common electrode.

In one embodiment of the foregoing power-saving device, the first switch conducts in a first stage and a fifth stage, the second switch conducts in a second stage and a fourth stage, and the third switch conducts in a third stage and a sixth stage. In the first stage, the first capacitor stores the positive electric charges from the ground-referenced equivalent capacitor of the common electrode. In the second stage, the negative electric charges of the second capacitor neutralize the positive electric charges of the ground-reference equivalent capacitor of the common electrode. In the third stage, the output buffer discharges the ground-reference equivalent capacitor of the common electrode to a target negative voltage. Thereafter, in a fourth stage, the second capacitor stores the negative electric charges from the ground-reference equivalent capacitor of common electrode. In the fifth stage, the positive electric charges of the first capacitor neutralize the negative electric charges of the ground-referenced equivalent capacitor of the common electrode. Then, in a sixth stage, the output buffer charges the ground-referenced equivalent capacitor of the common electrode to a target positive voltage.

From another perspective, the present invention also provides a power-saving device for a driving circuit of a liquid crystal display. The device comprises a data line, a first switch, a first capacitor, a second switch, a second capacitor, a third switch and an output buffer. The data line is used for transmitting signals required to display an image frame to a plurality of pixels of the liquid crystal display panel. The first switch is coupled to the data line. The first capacitor for storing positive electric charges is coupled to the first switch. Meanwhile, the second switch is also coupled to the data line. The second capacitor for storing negative electric charges is coupled to the second switch. The third switch is also coupled to the data line and the output buffer is coupled to the third switch so that the output buffer either charges or discharges a ground-referenced equivalent capacitor of the data line.

From another perspective, the present invention also provides another power-saving device for a driving circuit of a liquid crystal display panel. The device comprises a plurality of data lines, a plurality of first switches, a first capacitor, a plurality of second switches, a second capacitor, a plurality of third switches and a plurality of output buffers. The data lines are used for transmitting signals required to display an image frame to a plurality of pixels of the liquid crystal display panel. The first switches form a one-to-one correspondence with the data lines and each one of the first switches is coupled to a corresponding data line. The first capacitor is used for storing positive electric charges and is coupled to the first switches. The second switches also form a one-to-one correspondence with the data lines and each one of the second switches is coupled to a corresponding data line. The second capacitor is used for storing negative electric charges and is coupled to the second switches. The third switches also form one-to-one correspondence with the data lines and each one of the third switches is coupled to a corresponding data line. The output buffers form a one-to-one correspondence with the data lines and each of the output buffers is coupled to a corresponding third switch so that each of the output buffers either charges or discharges the ground-referenced equivalent capacitor of the corresponding data line.

In one embodiment of the foregoing power-saving device, if the voltage on one particular data line is greater than a preset voltage, the first switch corresponding to this data line conducts in the first stage. Then, the first capacitor stores the positive electric charges from the ground-referenced equivalent capacitor of the data line. The second switch corresponding to this data line is conductive in the second stage. The negative electric charges in the second capacitor neutralize the positive electric charges in the ground-referenced equivalent capacitor of the data line. If the voltage on this data line does not reach the target voltage after the second stage, and the target voltage is still smaller than the preset voltage, then the third switch corresponding to this data line conducts in the third stage. Thereafter, the output buffer corresponding to this data line discharges the ground-referenced equivalent capacitor of the data line to the target voltage. Here, the preset voltage is about half of the highest voltage on this data line.

In one embodiment of the foregoing power-saving device, if the voltage on one particular data line is smaller than a preset voltage, the second switch corresponding to this data line conducts in the first stage. Then, the second capacitor stores the negative electric charges from this ground-referenced equivalent capacitor of the data line. The first switch corresponding to this data line conducts in the second stage so that the positive electric charges of the first capacitor neutralize the negative electric charges of this ground-referenced equivalent capacitor of the data line. If the voltage on this data line does not reach the target voltage after the second stage, and the target voltage is still greater than the preset voltage, the third switch corresponding to this data line conducts in the third stage. Thereafter, the output buffer corresponding to this data line charges this ground-referenced equivalent capacitor of the data line up to the target voltage. The preset voltage is about half of the highest voltage on this data line.

Switches and capacitors are used in the present invention to store and recycle electric charges. Through the switching of switches, electric charges are stored in capacitors and then released from the capacitors so that the circuits performing the charging and discharging can save power through recycling of electric charges.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a timing diagram of source voltages and a common voltage in a liquid crystal display panel using an alternating common voltage.

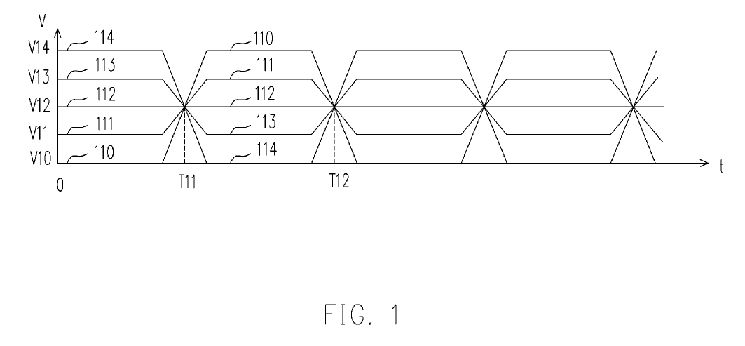

FIG. 2 is a circuit diagram of a conventional driving device of a liquid crystal display panel.

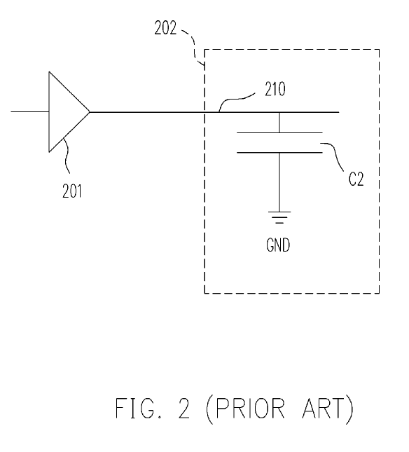

FIG. 3A is a circuit diagram of a power-saving device in a driving circuit of a liquid crystal display panel according to one embodiment of the present invention.

FIG. 3B is a timing diagram of the common voltage of the liquid crystal display panel in FIG. 3A.

FIG. 4A is a circuit diagram of power-saving devices in a driving circuit of a liquid crystal display panel according to another embodiment of the present invention.

FIG. 4B and FIG. 4C are timing diagrams of the data line voltage in FIG. 4A.

FIG. 5A is a circuit diagram of a power-saving device in a driving circuit of a liquid crystal display panel according to yet another embodiment of the present invention.

FIG. 5B and FIG. 5C are timing diagrams of the data line voltage in FIG. 5A.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

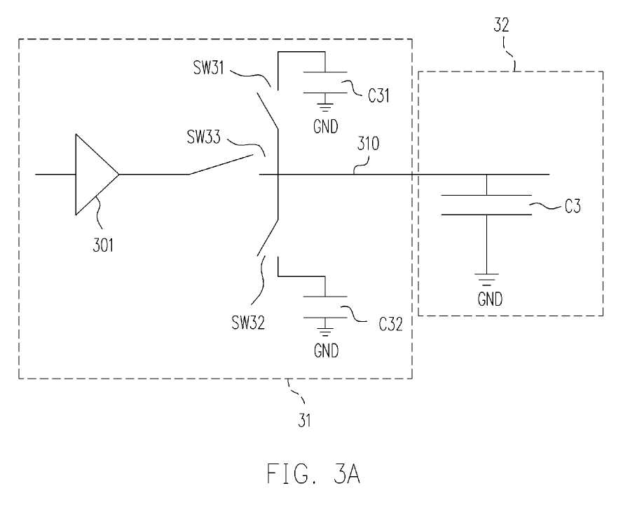

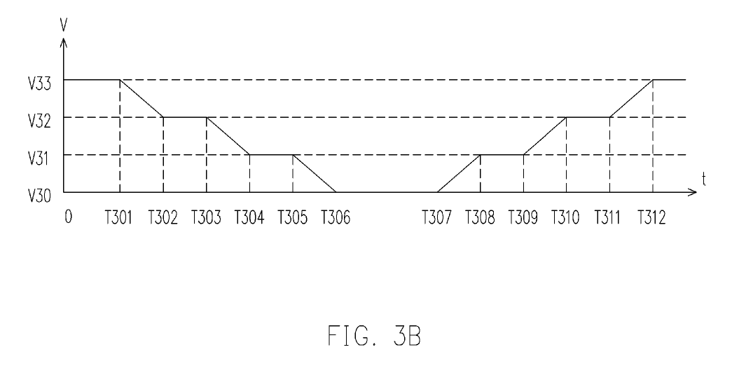

FIG. 3A is a circuit diagram of a power-saving device 31 in a driving circuit of a liquid crystal display panel according to one embodiment of the present invention. The power-saving device 31 is suitable for a liquid crystal display panel that uses an alternative common voltage. As shown in FIG. 3A, the power-saving device 31 comprises a common electrode 310, a first switch SW31, a second switch SW32, a first capacitor C31, a second capacitor C32, a third switch SW33 and an output buffer 301. The common electrode 310 of the power-saving device 31 is responsible for providing a common voltage to the liquid crystal display panel 301. One end of the first switch SW31 is coupled to the common electrode 310 while the other end of the first switch SW31 is coupled to the first capacitor C31. The first capacitor C31 is responsible for storing positive electric charges. One end of the second switch SW32 is coupled to the common electrode 310 while the other end of the second switch SW32 is coupled to the second capacitor C32. The second capacitor C32 is responsible for storing negative electric charges. The output buffer 301 is coupled to the third switch SW33 for charging or discharging a ground-referenced equivalent capacitor C3 of the common electrode 310.

FIG. 3B is a timing diagram of the common voltage of the liquid crystal display panel in FIG. 3A. To simplify the explanations, the vertical axis represents voltage and the horizontal axis represents time. As shown in FIGS. 3A and 3B, the common voltage switches from a positive voltage to a negative voltage in a time interval between 0˜T306 and the common voltage switches from the negative voltage to the positive voltage in a time interval between T307˜T312. During the time interval 0˜T301, none of the switches SW3, SW32 and SW33 conducts so that the common voltage is maintained at a high voltage V33. During the time interval T301 to T302 in the first stage, only the first switch SW31 conducts so that the first capacitor C31 can store some positive electric charges from the ground-referenced equivalent capacitor C3 of the common electrode 310. Because a portion of the positive electric charges in the ground-referenced equivalent capacitor C3 flows into the first capacitor C31, the common voltage drops from V33 to V32. During the time interval T302 to T303, the first switch SW31 switches to a non-conductive state so that the common voltage is maintained at the voltage of V32. During the time interval T303 to T304 in the second stage, only the second switch SW32 conducts so that the negative electric charges (the stored electric charges in the fourth stage of the previous cycle) already stored in the second capacitor C32 neutralize the positive electric charges in the ground-referenced equivalent capacitor C3 of the common electrode 310. Thus, the common voltage drops from V32 to V31. During the time interval T304 to T305, the second switch SW32 changes into a non-conductive state so that the common voltage is maintained at V31. During the time interval T305 to T306 in the third stage, only the third switch SW33 conducts so that the output buffer 310 discharges the ground-referenced equivalent capacitor C3 of the common electrode. Therefore, the voltage of the ground-referenced equivalent capacitor C3 drops from V31 to a target voltage V30.

During the time interval T306 to T307, none of the switches SW31, SW32 and SW33 conducts so that the common voltage is maintained at the negative voltage V30. During the time interval T307 to T308 in the fourth stage, only the second switch SW32 conducts so that the second capacitor C32 can store some negative electric charges from the ground-referenced equivalent capacitor C3 of the common electrode 310. Because a portion of the negative electric charges in the ground-referenced equivalent capacitor C3 flows into the second capacitor C32, the common voltage rises from V30 to V31. During the time interval T308 to T309, the second switch SW32 switches to a non-conductive state so that the common voltage is maintained at the voltage of V31. During the time interval T309 to T310 in the fifth stage, only the first switch SW31 conducts so that the positive electric charges (the stored electric charges in the aforementioned first stage) already stored in the first capacitor C31 neutralize the negative electric charges in the ground-referenced equivalent capacitor C3 of the common electrode 310. Thus, the common voltage rises from V31 to V32. During the time interval T310 to T311, the first switch SW31 changes into a non-conductive state so that the common voltage is maintained at V32. During the time interval T311 to T312 in the sixth stage, only the third switch SW33 conducts so that the output buffer 310 charges the ground-referenced equivalent capacitor C3 of the common electrode. Therefore, the voltage of the ground-referenced equivalent capacitor C3 rises from V32 to a target voltage V33.

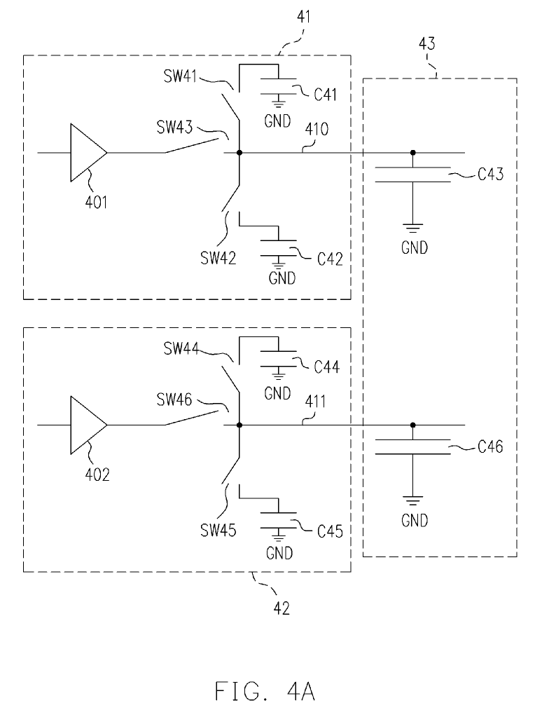

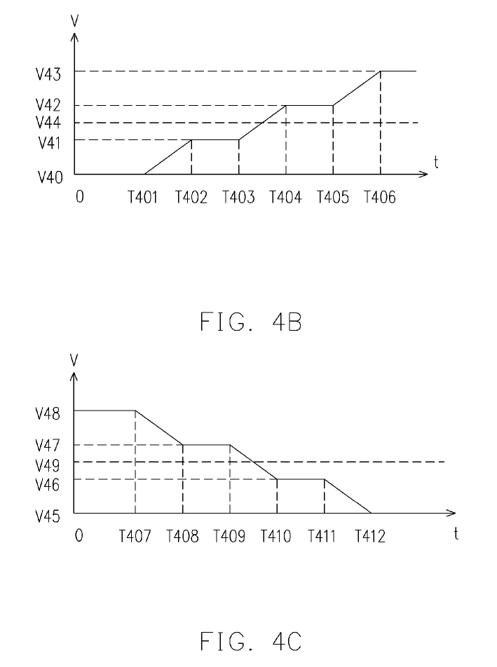

Beside applicable to a common electrode, the foregoing power-saving device can also be used in a data line of a liquid crystal display panel. FIG. 4A is a circuit diagram of power-saving devices in a driving circuit of a liquid crystal display panel according to another embodiment of the present invention. As shown in FIG. 4A, the power-saving devices 41 and 42 are coupled to the respective data lines 410 and 411 on the liquid crystal display panel 43. Each one of the data lines 410 and 411 has a ground-referenced equivalent capacitor C43 and C46 driven by the power-saving devices 41 and 42 respectively. Both the power-saving devices 41 and 42 have an identical structure and operating procedure. Therefore, to simplify the description, only the power-saving device 41 is explained in the following. The power-saving device 41 comprises a data line 410, a first switch SW41, a first capacitor C41, a second switch SW42, a second capacitor C42, a third switch SW43 and an output buffer 401. The first capacitor C41 stores positive electric charges. The first capacitor C41 is coupled to the data line 410 through the first switch SW41. The second capacitor C42 stores negative electric charges. The second capacitor C42 is coupled to the data line 410 through the second switch SW42. The output buffer 401 is coupled to the data line through the third switch SW43 so that the output buffer 401 either charges or discharges the ground-referenced equivalent capacitor C43 of the data line 410. The liquid crystal display panel shown in FIG. 4A only includes two data lines. However, the present invention sets no particular limit on the number of data lines in the liquid crystal display panel. The main point is that each data line has a corresponding power-saving device.

It does not matter if the common voltage in the liquid crystal display panel is constant or alternating, the voltage on the data line will change up and down according to the driving polarity. Using a preset voltage as a boundary, if the voltage on a particular data line with a positive polarity is smaller than this preset voltage, the voltage with a negative polarity must be greater than the preset voltage. On the contrary, if the voltage on a particular data line with a positive polarity is greater than the preset voltage, the voltage with a negative polarity must be smaller than the preset voltage. In the present embodiment, the preset voltage is set to a value at about half of the highest voltage on the data line.

FIG. 4B is a diagram showing a driving time curve of the data line voltage in FIG. 4A. To simplify the explanation, the vertical axis represents the voltage and the horizontal axis represents the time. FIG. 4B shown the voltage variation when the voltage on data line 410 is smaller than the preset voltage V44. As shown in FIGS. 4A and 4B, when the voltage V40 of the data line 410 is smaller than the preset voltage V44, the preset voltage V44 is about half of the highest voltage on the data line 410. Thus, during the time interval 0 to T401, none of the switches SW41, SW42, SW43 conduct so that the voltage is maintained at about V40. During the time interval T401 to T402 in the first stage, the second switch SW42 conducts so that the second capacitor C42 can store some of the negative electric charges from the ground-referenced equivalent capacitor C43. Hence, the data line voltage rises to V41. During the interval T402 to T403, the second switch SW42 changes into a non-conductive state so that the voltage on data line 410 is maintained at V41. During the time interval T403 to T404 in the second stage, the first switch SW41 conducts so that the positive electric charges originally stored in the first capacitor C41 neutralize the negative electric charges in the ground-referenced equivalent capacitor C43. Thus, the common voltage rises to V42. During the time interval T404 to T405, the first switch SW41 changes into a non-conductive state so that the voltage on data line 410 is maintained at V42. Because the voltage V42 on the data line 410 is smaller than the target voltage V43, and furthermore, the target voltage V43 is greater than the preset voltage V44, the operation proceeds to the third stage. During the time interval T405 to T406 in the third stage, the third switch SW43 conducts so that the output buffer 401 charges the ground-referenced equivalent capacitor C43 to the target voltage V43. If the voltage on data line 410 reaches the target positive voltage in the second stage, the charging in the third stage is unnecessary.

FIG. 4C is a diagram showing another driving time curve of the data line voltage in FIG. 4A. To simplify the explanation, the vertical axis represents the voltage and the horizontal axis represents the time. FIG. 4C shown the voltage variation when the voltage on data line 410 is greater than the preset voltage V49, which is about half of the highest voltage. As shown in FIGS. 4A and 4C, in the time interval 0 to T407, none of the switches in the power-saving device 41 conduct so that the voltage is maintained at V48. During the time interval T407 to T408 in the first stage, the first switch SW41 conducts so that the first capacitor C41 stores some of the positive electric charges in the ground-referenced equivalent capacitor C43. Hence, the voltage drops to V47. During the time interval T408 to T409, the first switch SW41 changes into a non-conductive state so that the voltage on data line 410 is maintained at V47. During the time interval T409 to T410 in the second stage, the second switch SW42 conducts so that the negative electric charges originally stored in the second capacitor C42 neutralize the positive electric charges in the ground-referenced equivalent capacitor C43. Thus, the voltage drops to V46. During the time interval T410 to T411, the second switch SW42 changes into a non-conductive state so that the voltage on data line 410 is maintained at V46. Because the voltage on the data line 410 does not reach the target voltage V45, and furthermore, the target voltage V45 is still smaller than the preset voltage V49, the operation proceeds to the third stage. During the time interval T411 to T412 in the third stage, the third switch SW43 conducts so that the output buffer 401 discharges the ground-referenced equivalent capacitor C43 to the target voltage V45. If the voltage on data line 410 reaches the target positive voltage in the second stage, the discharging in the third stage is unnecessary.

Returning to FIG. 4A, the power-saving device 42 comprises switches SW44, SW45, SW46, capacitors C44, C45, an output buffer 402 and a data line 411. The data line 411 has a ground-referenced equivalent capacitor C46. Since the power-saving device 42 has a structure identical to the power-saving device 41, an identical operation can be deduced.

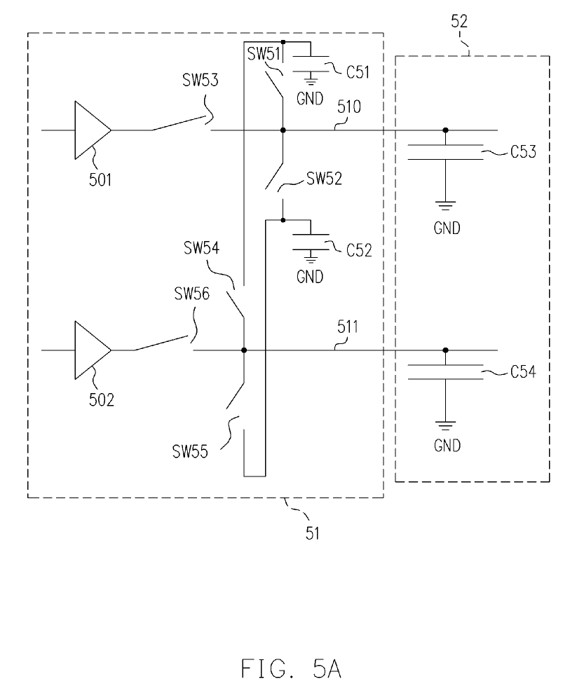

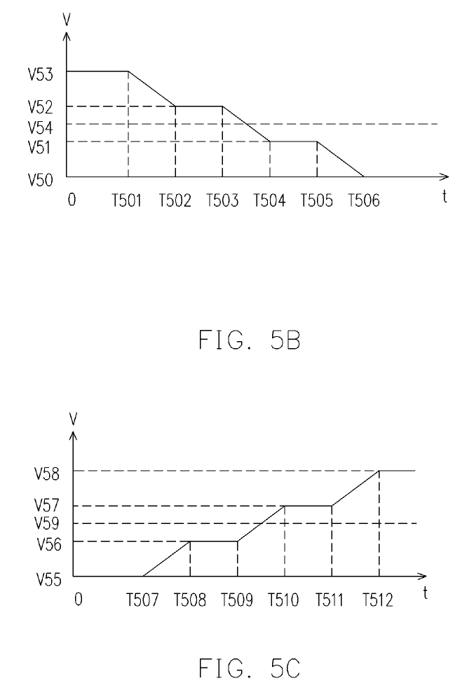

FIG. 5A is a circuit diagram of a power-saving device 51 in a driving circuit of a liquid crystal display panel according to yet another embodiment of the present invention. As shown in FIG. 5A, the power-saving device 51 comprises data lines 510 and 511, first switches SW51 and SW54, a first capacitor C51, second switches SW52 and SW55, a second capacitor C52, third switches SW53 and SW56, output buffers 501 and 502. One main difference between the power-saving devices in FIG. 5A and FIG. 4A is that each data line in FIG. 4A has two capacitors for storing positive and negative electric charges while the data lines in FIG. 5A all use the same two capacitors for storing positive and negative electric charges.

FIG. 5B is a diagram showing a driving time curve of the data line voltage in FIG. 5A. To simplify the explanation, the vertical axis represents the voltage and the horizontal axis represents time. FIG. 5B shows the voltage variation when the voltage on data line 510 is greater than a preset voltage V54. As shown in FIGS. 5A and 5B, the preset voltage V54 is about half of the highest voltage on the data line 510 when the voltage V53 on the data line 510 is greater than the preset voltage V54. In the time interval 0 to T501, none of the switches conduct so that the voltage is maintained at V54. During the time interval T501 to T502 in the first stage, the first switch SW51 conducts so that the first capacitor C51 stores some of the positive electric charges in the ground-referenced equivalent capacitor C53. Thus, the voltage on data line 510 drops to V52. In the time interval T502 to T503, none of the switches conduct so that the voltage on data line 510 is maintained at V52. During the time interval T503 to T504 in the second stage, the second switch SW52 conducts so that the negative electric charges originally stored in the second capacitor C52 neutralize the positive electric charges of the ground-referenced equivalent capacitor C53. Hence, the voltage drops to V51. In the time interval T504 to T505, none of the switches conduct so that the voltage is maintained at V51. At this moment, because the voltage on data line 510 does not reach the target negative voltage V50, and furthermore, the target negative voltage V50 is still smaller than the preset voltage V54, the operation proceeds to the third stage. During the time interval T505 to T506 in the third stage, the third switch SW53 conducts so that the output buffer 501 can discharge the ground-referenced equivalent capacitor C53 to the target negative voltage V50. If the voltage on data line 510 reaches the target negative voltage for driving in the second stage, the discharging in the third stage is unnecessary.

FIG. 5C is a diagram showing another driving time curve of the data line voltage in FIG. 5A. To simplify the explanation, the vertical axis represents the voltage and the horizontal axis represents time. FIG. 5C shows the voltage variation when the voltage on data line 510 is smaller than the voltage variation of the preset voltage V59, which is about half of the highest voltage. As shown in FIGS. 5A and 5C, in the time interval 0 to T501, none of the switches conduct so that the voltage on data line 510 is maintained at V55. During the time interval T507 to T508 in the first stage, the second switch SW52 conducts so that the second capacitor C52 stores some of the negative electric charges in the ground-referenced equivalent capacitor C53. Thus, the voltage on data line 510 rises to V56. In the time interval T508 to T509, the second switch SW52 changes into a non-conductive state so that the voltage on data line 510 is maintained at V56. During the time interval T509 to T510 in the second stage, the first switch SW51 conducts so that the positive electric charges originally stored in the first capacitor C51 neutralize the negative electric charges of the ground-referenced equivalent capacitor C53. Hence, the voltage on data line 510 rises to V57. In the time interval T510 to T511, the first switch SW51 changes into a non-conductive state so that the voltage on data line 510 is maintained at V57. At this moment, because the voltage on data line 510 does not reach the target positive voltage V58, and furthermore, the target positive voltage V58 is still greater than the preset voltage V59, the operation proceeds to the third stage. During the time interval T511 to T512 in the third stage, the third switch SW53 conducts so that the output buffer 501 can charge the ground-referenced equivalent capacitor C53 to the target positive voltage V58. If the voltage on data line 510 reaches the target positive voltage for driving in the second stage, the charging in the third stage is unnecessary.

Returning to FIG. 5A, the first capacitor C51 and the second capacitor C52 are also coupled to the data line 511 through first switches SW54 and SW55. Therefore, the first capacitor C51 and the second capacitor C52 are shared by both the data line 510 and the data line 511. The positive electric charges are stored in the first capacitor C51 and the negative electric charges are stored in the second capacitor C52. In addition, the data line 511 operates on the first capacitor C51 and the second capacitor C52 in the same way as the data line 510. Furthermore, FIG. 5A only shows a liquid crystal display panel 52 with two data lines. However, the present invention sets no particular limit on the number of data lines in the liquid crystal display panel. The main point is that all the data lines share the same two capacitors, one for storing negative electric charges and one for storing positive electric charges, by deploying a plurality of switches. Since anyone familiar in this area can make the necessary modifications, a detail analysis is not provided.

In summary, switches and capacitors are used in the present invention to store positive and negative electric charges so that the electric charges can be reused in the driving circuits for data lines and common electrodes to minimize power waste.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A power-saving device for a driving circuit of a liquid crystal display panel, particularly suitable for a liquid crystal display panel using an alternating common voltage, comprising:
a common electrode for providing a common voltage to a liquid crystal display panel;
a first switch coupled to the common electrode;
a first capacitor coupled to the first switch for storing positive electric charges;
a second switch coupled to the common electrode;
a second capacitor coupled to the second switch for storing negative electric charges;
a third switch coupled to the common electrode; and
an output buffer coupled to the third switch for charging or discharging a ground-referenced equivalent capacitor of the common electrode.

2. The power-saving device of claim 1, wherein:
the first switch conducts in a first stage and a fifth stage;
the second switch conducts in a second stage and a fourth stage;
the third switch conducts in a third stage and a sixth stage.

3. The power-saving device of claim 2, wherein the first, the second and the third stages happen when the common voltage switches from a positive polarity to a negative polarity, and the fourth, the fifth and the sixth stages happen when the common voltage switches from the negative polarity to the positive polarity; wherein the common voltage is defined as the positive polarity when the common voltage is greater than a preset voltage, and the common voltage is defined as the negative polarity when the common voltage is smaller than the preset voltage.

4. The power-saving device of claim 2, wherein:
in the first stage, the first capacitor stores the positive electric charges from the ground-referenced equivalent capacitor;
in the second stage, the negative electric charges in the second capacitor neutralize the positive electric charges of the ground-referenced equivalent capacitor;
in the third stage, the output buffer discharge the ground-referenced equivalent capacitor to a target negative voltage;
in the fourth stage, the second capacitor stores the negative electric charges from the ground-referenced equivalent capacitor;
in the fifth stage, the positive electric charges of the first capacitor neutralize the negative electric charges of the ground-referenced equivalent capacitor; and
in the sixth stage, the output buffer charges the ground-reference equivalent capacitor to a target positive voltage.

5. A power-saving device for a driving circuit of a liquid crystal display panel, comprising:
a data line for transmitting signals required to display an image frame to a plurality of pixels of a liquid crystal display panel;
a first switch coupled to the data line;
a first capacitor coupled to the first switch for storing positive electric charges;
a second switch coupled to the data line;
a second capacitor coupled to the second switch for storing negative electric charges;
a third switch coupled to the data line; and
an output buffer coupled to the third switch for charging or discharging a ground-referenced equivalent capacitor of the data line.

6. The power-saving device of claim 5, wherein:
if the voltage on the data line is greater than a preset voltage, then:
the first switch conducts in a first stage;
the second switch conducts in a second stage;
if the voltage on the data line does not reach a target voltage after the second stage, then:
the third switch conducts in a third stage, wherein the target voltage is smaller than the preset voltage.

7. The power-saving device of claim 6, wherein:
in the first stage, the first capacitor stores the positive electric charges from the ground-referenced equivalent capacitor;
in the second stage, the negative electric charges of the second capacitor neutralize the positive electric charges of the ground-referenced equivalent capacitor; and
in the third stage, if the third switch conducts, then the output buffer discharges the ground-referenced equivalent capacitor to the target voltage.

8. The power-saving device of claim 6, wherein the preset voltage is about half of the highest voltage on the data line.

9. The power-saving device of claim 5, wherein:
if the voltage on the data line is smaller than a preset voltage, then:
the second switch conducts in a first stage;
the first switch conducts in a second stage;
if the voltage on the data line does not reach a target voltage after the second stage, then:
the third switch conducts in a third stage, wherein the target voltage is greater than the preset voltage.

10. The power-saving device of claim 9, wherein:
in the first stage, the second capacitor stores the negative electric charges from the ground-referenced equivalent capacitor;
in the second stage, the positive electric charges of the first capacitor neutralize the negative electric charges of the ground-referenced equivalent capacitor; and
in the third stage, if the third switch conducts, then the output buffer charges the ground-referenced equivalent capacitor to the target voltage.

11. The power-saving device of claim 9, wherein the preset voltage is about half of the highest voltage on the data line.

12. A power-saving device for a driving circuit of a liquid crystal display panel, comprising:
a plurality of data lines for transmitting signals required to display an image frame to a plurality of pixels of a liquid crystal display panel;
a plurality of first switches that corresponds with the respective data lines such that each first switch is coupled to a corresponding data line;
a first capacitor coupled to the first switches for storing positive electric charges;
a plurality of second switched that corresponds with the respective data lines such that each second switch is coupled to a corresponding data line;
a second capacitor coupled to the second switches for storing negative electric charges;
a plurality of third switches that corresponds to the data lines such that each third switch is coupled to a corresponding data line; and
a plurality of output buffers that corresponds with the data lines such that each output buffer is coupled to a corresponding third switch for charging or discharging the ground-referenced equivalent capacitor of the corresponding data line.

13. The power-saving device of claim 12, wherein:
if the voltage on one of the data lines is greater than a preset voltage, then:
the first switch corresponding to the data line conducts in a first stage;
the second switch corresponding to the data line conducts in a second stage;
if the data line voltage does not reach a target voltage after the second stage, then the third switch corresponding to the data line conducts in a third stage, wherein the target voltage is smaller than the preset voltage.

14. The power-saving design of claim 13, wherein:
in the first stage, the first capacitor stores the positive electric charges from the ground-referenced equivalent capacitor of the data line;
in the second stage, the negative electric charges of the second capacitor neutralize the positive electric charges of the ground-referenced equivalent capacitor; and
in the third stage, if the third switch conducts, then the output buffer corresponding to the data line discharges the ground-referenced equivalent capacitor to the target voltage.

15. The power-saving device of claim 13, wherein the preset voltage is about half of the highest voltage on the data line.

16. The power-saving device of claim 12, wherein:
if the voltage on one of the data lines is smaller than a preset voltage, then:
the second switch corresponding to the data line conducts in a first stage;
the first switch corresponding to the data line conducts in a second stage;
if the voltage on the data line does not reach a target voltage after the second stage, then the third switch corresponding to the data line conducts in a third stage, wherein the target voltage is greater than the preset voltage.

17. The power-saving device of claim 16, wherein:
in the first stage, the second capacitor stores the negative electric charges from the ground-referenced equivalent capacitor of the data line;
in the second stage, the positive electric charges of the first capacitor neutralize the negative electric charges of the ground-referenced equivalent capacitor; and
in the third stage, if the third switch conducts, then the output buffer corresponding to the data line charges the ground-referenced equivalent capacitor to the target voltage.

18. The power-saving device of claim 16, wherein the preset voltage is about half of the highest voltage on the data line.
